(19) United States
(12) Patent Application Publication
(10) Pub. No.: US 2015/0102246 A1
(43) Pub. Date: Apr. 16, 2015

(54) Interlocking Spring Seat Assembly and Rotary Control Valve Comprising Same

(71) Applicant: FISHER CONTROLS INTERNATIONAL LLC, Marshalltown, IA (US)

(72) Inventors: Bryan Q. Leger, Marshalltown, IA (US); David J. Koester, Gladbrook, IA (US)

(73) Assignee: FISHER CONTROLS INTERNATIONAL LLC, Marshalltown, IA (US)

(21) Appl. No.: 14/052,923

(22) Filed: Oct. 14, 2013

(51) Int. Cl. F16K 1/226

(52) U.S. Cl. CPC F16K 1/2266
USPC 251/180

(57) ABSTRACT

A spring seat assembly for a fluid valve includes a first spring seat having a first protruding member extending away from a first seating surface and a second spring seat having a second protruding member extending away from a second seating surface, the first spring seat being slidable relative to the second spring seat. A spring is disposed between the first seating surface and the second seating surface. A locking element is disposed on at least one of the first protruding member and the second protruding member.

### FIELD OF THE DISCLOSURE

The disclosure generally relates to spring seat assemblies for rotary control valves and more specifically to spring seat assemblies having an interlocking mechanism to allow pre-compression of the spring seat assembly during manufacture.

### BACKGROUND OF THE DISCLOSURE

Valves are commonly used in process control systems to control the flow of process fluids. Rotary valves (e.g., butterfly valves) typically have a closure member (e.g., a disk) disposed in a fluid path. A shaft operatively couples the closure member to an actuator that rotates the closure member between an open position and a closed position to allow or restrict the flow of fluid between an inlet and an outlet of the valve. When the closure member is rotated to the closed position, the closure member sealingly engages a valve seat or sealing surface (e.g., a seal ring fixed to the valve body) to restrict the flow of fluid through the valve.

A peripheral edge of the closure member is used as a seal contact surface for the valve and must be properly aligned with the sealing surface to affect a proper seal. Thus, to affect a proper seal, it is important that the closure member be precisely positioned within the valve body so that the peripheral edge of the closure member can sealingly mate or engage the sealing surface. Due to the requirement for precise alignment of the valve closure member relative to the valve sealing surface, rotary valves often cannot be installed in a vertical orientation. In particular, the weight of the valve components or valve trim (e.g., a drivetrain) can cause the closure member to shift and become misaligned with the valve body and sealing surface, thereby comprising the integrity of the seal and causing undesired leakage through the valve (i.e., a quantity of fluid passing through the valve when the valve is in the closed position). As a result, some rotary control valves include a biasing assembly that provides a force that opposes the weight of the valve components. U.S. Pat. No. 8,070,130, which is hereby incorporated by reference herein, discloses one such biasing assembly. However, the components of the biasing assembly disclosed in U.S. Pat. No. 8,070,130 are not easily assembled because each element must be assembled separately one at a time.

### SUMMARY

In accordance with one exemplary aspect of the present invention, a spring seat assembly for a fluid valve includes a first spring seat having a first protruding member extending away from a first seating surface and a second spring seat having a second protruding member extending away from a second seating surface, the first spring seat being slidable relative to the second spring seat. A spring is disposed between the first seating surface and the second seating surface. A locking element is disposed on at least one of the first protruding member and the second protruding member.

In another exemplary aspect of the present invention, a fluid valve includes a valve body having a fluid inlet and a fluid outlet, a closure member disposed within the valve body, the closure member being operatively coupled to a drive shaft and a follower shaft; and a valve seat disposed within the valve body, the valve seat cooperating with the closure member to control fluid flow through the valve body. A spring seat assembly is operatively coupled to the follower shaft, the spring seat assembly including a first spring seat having a first protruding member extending away from a first seating surface, a second spring seat having a second protruding member extending away from a second seating surface, a spring disposed between the first seating surface and the second seating surface, and a locking element disposed on at least one of the first protruding member and the second protruding member.

In further accordance with any one or more of the foregoing aspects, a spring seat assembly (or a fluid valve having a spring seat assembly) may further include any one or more of the following preferred forms.

In some preferred forms, the first protruding member includes two legs and/or the second protruding member includes two legs. In other preferred forms, the locking element is a hook. In yet other preferred forms, the hook includes an angled surface that is angled relative to a longitudinal axis of the spring seat assembly. In yet other preferred forms, the angled surface forms an angle of between 30° and 90° relative to the longitudinal axis of the spring seat assembly. In yet other preferred forms, the hook includes a shelf surface that is substantially perpendicular to a longitudinal axis of the spring seat assembly. In yet other preferred forms, a distal end of one of the first protruding member and the second protruding member includes a chamfered surface. In yet other preferred forms, the locking element limits relative movement between the first spring seat and the second spring seat to less than an uncompressed length of the spring. In yet other preferred forms, one of the first protruding member and the second protruding member includes a curved outer surface.

### BRIEF DESCRIPTION OF THE DRAWINGS

FIG. 1 is a longitudinal cross-sectional view of a rotary control valve including a spring seat assembly;

FIG. 2 is a close up cross-sectional view of the spring seat assembly of FIG. 1;

FIG. 3A is a perspective view of the spring seat assembly of FIG. 1 removed from the control valve;

FIG. 3B is a perspective view of two torsional spring seats of the spring seat assembly of FIG. 1;

FIG. 3C is a perspective view of the two torsional spring seats of FIG. 3B separated by a distance;

FIG. 3D is a perspective exploded view of an alternative embodiment of the spring seat assembly of FIG. 1; and

FIG. 4 is a side cross-sectional view of one embodiment of a first protruding member of the spring seat assembly of FIG. 3D.

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the invention.

### DETAILED DESCRIPTION

Generally, the example spring seat assembly described herein may be used to maintain proper alignment (e.g., centering) of a rotary valve closure member relative to a valve seat or sealing surface of the valve body to prevent undesired leakage through the valve. The spring seat assemblies described herein are particularly advantageous when the rotary valves (e.g., control valves, throttling valves, etc.) are mounted in a vertical orientation (i.e., so that the longitudinal axis of the valve shaft is vertically oriented). More specifically, when a rotary valve is mounted in a vertical orientation, the weight of the valve components (e.g., the drive shaft, the closure member, the follower shaft, etc.) can cause the closure member to become misaligned relative to the sealing surface of the valve body. Such misalignment can result in a poor seal between the closure member and the sealing surface which, in turn, results in undesirable leakage through the valve. Additionally, the spring seat assemblies described herein advantageously may be pre-assembled as a single unit.

The example spring seat assemblies described herein provide a force to oppose the weight of the valve components to maintain alignment of the closure member relative to the valve body so that the closure member can sealingly engage the sealing surface and prevent undesired leakage. Additionally, in one example, a biasing apparatus includes a spring disposed between two spring seats that slidably engage and interlock and that can move (i.e., slide) relative to one another along an axis of the spring, but which are fixed (i.e., cannot rotate) relative to each other along an axis of the spring. In this manner, in addition to maintaining alignment of a valve closure member, the example biasing apparatus described herein can reduce or eliminate spring fatigue and/or failure by substantially preventing or reducing torsional loading on the spring caused by the closure member rotating between an open and a closed position. The example spring seat assembly described herein may be provided as a factory installed option or, alternatively, can be retrofit existing rotary valves in the field by being installed as a single assembly.

Furthermore, the example spring seat assemblies includes an interlocking feature on the legs of the respective spring seats so that once assembled, the spring seat will remain assembled even when not installed in a valve. As a result, the disclosed interlocking spring seat assemblies may be pre-assembled as a sub-assembly before installation in a fluid valve. Additionally, by pre-assembling the spring seat assemblies, shorter installation studs may be used when installing the spring seat assembly into a valve body, which results in quicker and more economical installations.

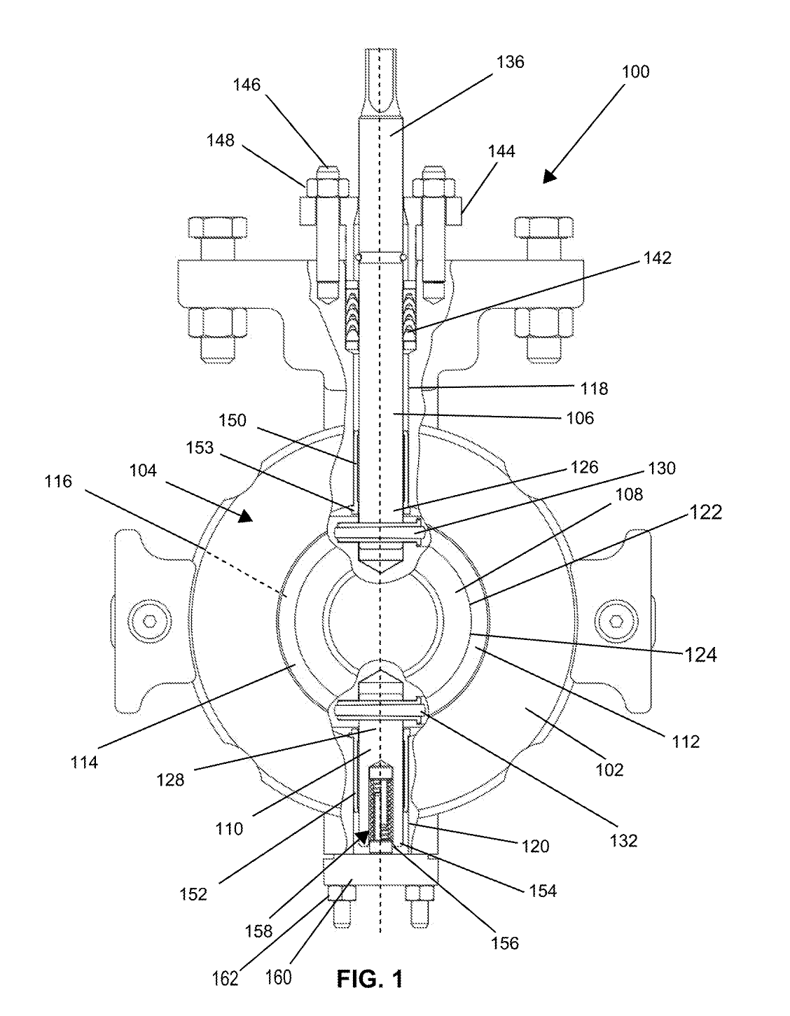

FIG. 1 is a longitudinal cross-sectional view of an example rotary control valve 100. The example valve 100 includes a valve body 102 that houses a drivetrain 104. The drivetrain 104 includes a drive shaft 106, a closure member 108 (e.g., a disk), and a follower shaft 110. The drive shaft 106 and follower shaft 110 may be of unitary or single piece construction (e.g., the drive shaft 106 and the follower shaft 110 may be integrally formed in some embodiments). The valve body 102 is generally cylindrical and has a central opening 112 that defines a fluid flow passageway between a fluid inlet 114 and a fluid outlet 116. The valve body 102 also has a first or drive end opening 118 and a second or follower end opening 120 that are generally coaxially aligned and adapted to receive the drive shaft 106 and the follower shaft 110, respectively. In other example implementations, the valve 100 may include a shaft that extends through the opening 118 and at least partially through opening 120 and is operatively coupled to the closure member 108 via fasteners, pins, etc.

The closure member 108 is disposed within the fluid flow passageway and is illustrated as a disk having a peripheral edge 122 that sealingly engages a valve seat or annular sealing surface 124 (e.g., a seal ring) disposed in the central opening 112 to prevent the flow of fluid through the valve 100. The closure member 108 is operatively coupled to a first end 126 of the drive shaft 106 and to a first end 128 of the follower shaft 110 via pins 130 and 132, respectively. In other embodiments, the closure member 108 may be operatively coupled to the drive shaft 106 and the follower shaft 110 by other connections, such as nuts, bolts, welds, adhesives, rivets, etc.

An actuator (not shown) may be operatively coupled to a second end 136 of the drive shaft 106 to drive the closure member 108 between a closed position and an open position to control the flow of fluid through the valve 100. The second end 136 of the drive shaft 106 may be a splined end, a square end, a round end, or virtually any other shape that allows the second end 136 to operatively couple to the actuator.

The valve 100 may include a packing 142 that is disposed in the opening 118 of the valve body 102 and which engages the drive shaft 106 to prevent fluid leaks. A packing flange 144 may adjust and retains the packing 142 within the valve body 102 and may couple to the valve body 102 via packing flange studs 146 and bolts 148. Bearings 150 and 152 may be disposed in the openings 118 and 120, respectively, between the drive shaft 106 and the follower shaft 110 and the valve body 102 to facilitate rotation of the drive shaft 106 and the follower shaft 110. The bearing 150 may align the closure member 108 along an axis 151 of the drive shaft 106 and a bearing flange 153 may align or center the closure member 108 relative to the central opening 112 and to the valve body 102. The bearings 150 and 152 may also aid the shafts 106 and 110 in alignment and rotation, and may also reduce friction between the shafts 106 and 110 and the valve body 102.

A second end 154 of the follower shaft 110 may include a bore or aperture 156 to receive a spring seat assembly 158. An end cap 160 may retain the spring seat assembly 158 within the bore 156 of the follower shaft 110 and may be operatively coupled to the valve body 102 via fasteners 162. In other example embodiments, a packing may be disposed in the opening 120 and a packing flange may be coupled to the valve body 102 to retain the packing and the spring seat assembly 158 within the bore 156 of the follower shaft 110. The follower shaft 110 may be formed as a substantially unitary piece via machining and/or any other suitable processes. Additionally or alternatively, the follower shaft 110 may be retrofit to include an elongated bore (e.g., the bore 156) by, for example, machining, to receive the spring seat assembly.

In operation, the actuator drives the closure member 108 between an open position to allow the flow of fluid through the valve 100 and a closed position to restrict the flow of fluid through the valve 100. The closure member 108 engages the sealing surface 124 to effect a seal and provide a shutoff (i.e., prevent the flow of fluid through the valve 100). The spring seat assembly 158 provides a force (e.g., an axial force along the longitudinal axis 151) to oppose the weight of the drivetrain 104 and biases the control member 108 against or toward the bearing 150 and axially along the longitudinal axis 151 when the valve 100 is mounted in a vertical or substantially vertical orientation. The spring seat assembly 158 provides an axial force along the longitudinal axis 151 to bias and/or maintain the alignment or position of the closure member 108 relative to the sealing surface 124 so that the closure member 108 is substantially centered and/or correctly positioned within the valve body 102. As a result, the peripheral edge 122 of the disk 108 can sealingly mate or engage the sealing surface 124 to prevent undesired leakage through the valve 100. Thus, the spring seat assembly 158 prevents the closure member 108 from shifting axially along the longitudinal axis 151 and becoming misaligned relative to the sealing surface 124.

In the illustrated example, the closure member 108 is depicted as a disk. However, in other example implementations, the closure member 108 may be any suitable closure member 108 such as, for example, a segmented ball, etc. Additionally or alternatively, the example described in connection with the spring seat assembly 158 is not limited to the example valve 100 illustrated in FIG. 1 and may be used with other types of rotary valves such as, for example, a ball valve, a segmented ball valve, etc.

Additionally, as discussed above, the example spring seat assembly 158 described herein may be retrofit to existing rotary valves in the field. For example, to retrofit a valve, a pin (e.g., the pin 132) and an end cap (e.g., the end cap 160) of a valve are removed and a follower shaft of the valve is detached from a closure member (e.g., the closure member 108) and removed from a valve body (e.g., the valve body 102). A follower shaft (e.g., the follower shaft 110) having a bore (e.g., the bore 156) and a spring seat assembly (e.g., the spring seat assembly 158) may replace the follower shaft of the valve already in the field. The replacement follower shaft may be coupled or reattached to the closure member and the end cap may be reattached to the valve body.

In other example implementations, a follower shaft of a valve already in the field may be detached from a closure member (e.g., the closure member 108) and removed from a valve body (e.g., the valve body 102). The shaft may be modified to include a bore (e.g., via machining, etc.) that is sized to receive a spring seat assembly (e.g., the spring seat assembly 158). The modified shaft may then coupled or reattached to the closure member and the biasing apparatus may be disposed at least partially within the bore of the shaft. The end cap may be reattached to the valve body and retains the biasing apparatus within the bore.

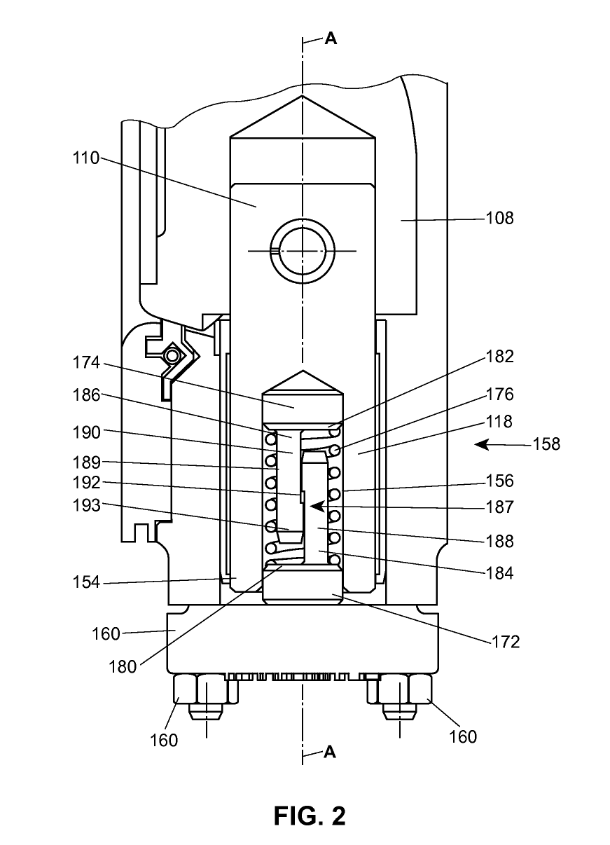

FIG. 2 is a close-up view of the spring seat assembly 158. The spring seat assembly 158 includes a first spring seat 172 and a second spring seat 174 that are slidable relative to one another along a longitudinal axis A of the spring seat assembly 158. A spring 176 biases the first spring seat 172 and the second spring seat 174 away from one another along the longitudinal axis A. The spring 176 seats against the first spring seat 172 at a first seating surface 180 and against the second spring seat 174 at a second seating surface 182. The first seating surface 180 and the second seating surface 182 may be oriented substantially perpendicular to the longitudinal axis A.

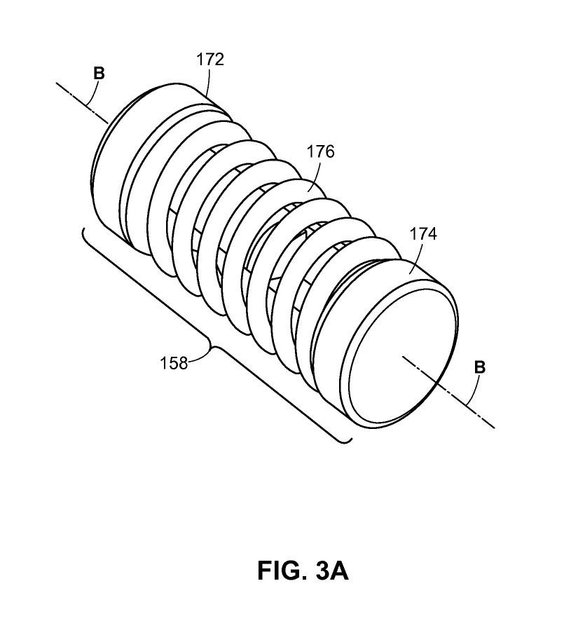

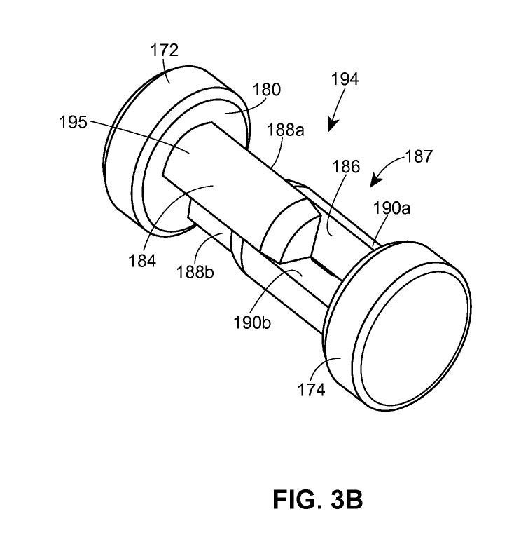

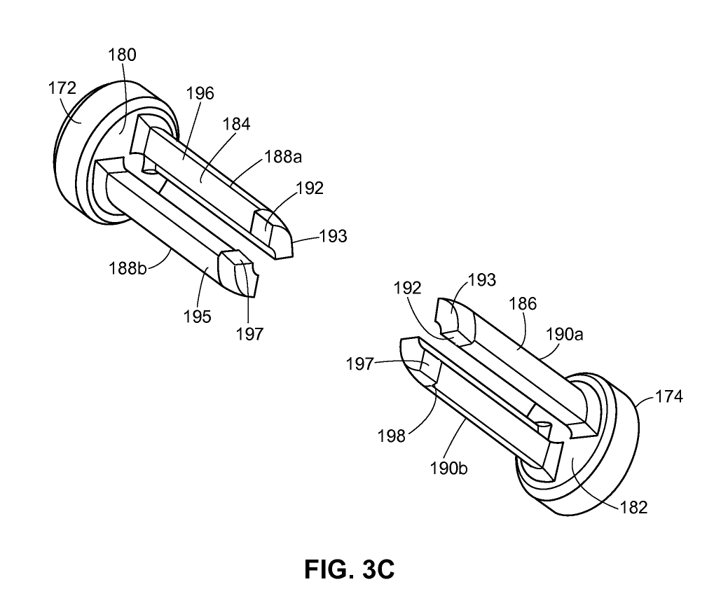

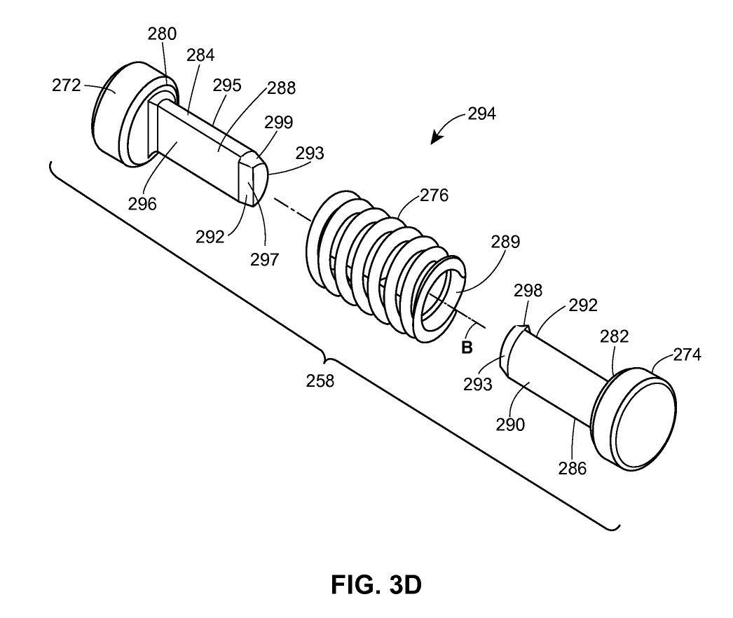

A first protruding member 184 extends longitudinally away from the first seating surface 180 and a second protruding member 186 extends longitudinally away from the second seating surface 182. The first protruding member 184 may include one or more legs 188 and the second protruding member 186 may include one or more legs 190. In a preferred embodiment, the first protruding member 284 and the second protruding member 286 may include a single leg 288, 290, as illustrated in FIG. 3D. In other embodiments, the first protruding member 184 and the second protruding member 186 may include a plurality of legs 188a, 188b, 190a, 190b, as illustrated in FIGS. 2 and 3A-3C. Regardless, when located adjacent to one another, the first protruding member 184 and the second protruding member 186 form a central pillar 187 that extends through an open center 189 of the spring 176. The central pillar 187 prevents the spring 176 from sliding off of the first or second spring seat 172, 174.

The first and second protruding members 184, 186, may have a locking element or hook 192 located proximate a distal end 193, away from the respective seating surfaces 180, 182. The hooks 192 are oriented towards one another when the spring seat assembly 158 is assembled. The hooks 192 form longitudinal stops that limit longitudinal travel of the first spring seat 172 and the second spring seat 174 away from one another. The hooks 192 advantageously prevent the first and second spring seats 172, 174 from separating enough to release the spring 176, and thus make it possible to pre-assemble the spring seat assembly 158 without fear of the spring seat assembly 158 coming apart before installation into the valve 100.

FIGS. 3A-3C are perspective views of an example spring seat assembly 158, each protruding member 184, 186 including two legs 188a, 188b, and 190a, 190b, respectively. FIG. 3D illustrates a preferred embodiment of a spring seat assembly 258 where the first and second protruding members 284, 286 each have a single leg 288, 290.

Referring to FIGS. 3A-3D, the example spring seat assemblies 158, 258 each include a first portion or first spring seat 172, 272, a second portion or second spring seat 174, 274 and a spring 176, 276 (e.g., a coil spring, a helical spring, etc.) disposed therebetween. The first spring seat 172, 272 and the second spring seat 174, 274 form a body 194, 294 that is sized so that at least a portion of the body 194, 294 can be received by a bore (e.g., the bore 156 of FIG. 1) of a shaft (e.g., the follower shaft 110 of FIG. 1). The first spring seat 172, 272 includes a first seating surface 180, 280 and a first protruding member 184, 284 and the second spring seat 174, 274 includes a second seating surface 182, 282 and a second protruding member 190, 290.

In the illustrated example of FIGS. 3A-3D, the first protruding member 184, 284 slidably couples to the second protruding member 186, 286 so that the first spring seat 172, 272 can slide relative to the second spring seat 174, 274. To slidably couple the first and second spring seats 172, 272 and 174, 274, the legs 188, 288 of the first spring seat 172, 272 slidably couple or interlock with the second legs 190, 290 of the second spring seat 174, 274. The legs 188, 288 and 190, 290 may have curved outer surfaces 195, 295 and substantially flat surfaces 196, 296, which form complementary shaped interlocking portions. When the first and the second protruding members 184, 284 and 186, 286 are coupled or interlocked together, the flat surfaces 196, 296 of the legs 188, 288 and 190, 290 slidably engage one another. When engaged or coupled, the protruding members 184, 284 and 186, 286 have a transverse cross-sectional shape or area that is generally circular. In other example embodiments, the protruding members 184, 284 and 186, 286, when coupled together, can have a polygonal-shaped (e.g., square, rectangular, etc.) transverse cross-sectional shape or area.

In the illustrated examples, the first spring seat 172, 272 can move relative to the second spring seat 174,274 along an axis B of the spring 176, 276. However, the first spring seat 172, 274 is rotatably fixed about the axis B relative to second spring seat 174, 274 due to the interaction between the legs 188, 288 and 190, 290. As a result, the spring 176, 276 can be compressed and extended along its longitudinal axis B, but a first end of the spring 176, 276 cannot rotate or twist relative to a second end of the spring 176, 276 about the axis B. Thus, the example spring seat assemblies 158, 258 prevent the first end of the spring 176, 276 from twisting or rotating relative to the second end of the spring 176, 276 as a result of a closure member (e.g., the closure member 108 of FIG. 1) rotating between an open and a closed position. In this manner, the example spring seat assemblies 158, 258 substantially prevent or reduce torsional loading on the spring 176, 276, thereby reducing or eliminating spring fatigue and/or failure.

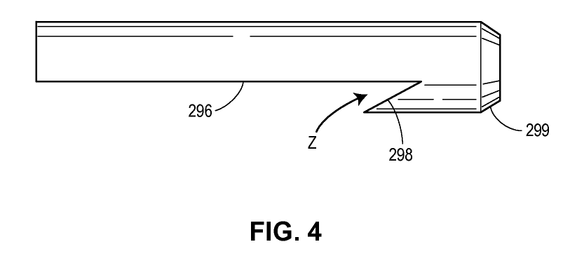

The legs 188, 288, and 190, 290 include hooks 192, 292 or other locking mechanisms at distal ends 193 thereof that are separated from the respective first seating surface 180, 280, and second seating surface 182, 282. When the legs 188, 288, 190, 290 are generally aligned with and longitudinally proximate to one another with the spring 176, 276 disposed between the seating surfaces 180, 280 and 182, 282, the hooks 192, 292 form longitudinal stops that prevent the first spring seat 172, 272 and the second spring seat 174, 274 from moving away from one another by more than a predetermined or working distance. This predetermined working distance is less than an uncompressed length of the spring 176, 276. Thus, the hooks 192, 292 maintain the spring seat assembly 258, 358 in an assembled condition as a single unit. The hooks 192, 292 may include an angled first surface 197, 297 and a shelf surface 198, 298 that is substantially perpendicular to the longitudinal axis B of the spring seat assembly 258, 358. The first angled surfaces 197, 297 facilitate assembly of the spring seat assembly 158, 258 by forcing the hooks 192, 292 past one another as the first and second spring seats 172, 272, and 174, 27 are moved longitudinally towards one another while being disposed in the central opening 189, 289 of the spring 176, 276. Once the hooks 192, 292 pass one another, the shelf surfaces 198, 298 prevent the first and second spring seats 172, 272 and 174, 274 from moving longitudinally away from one another more than the predetermined working distance. The shelf surfaces 198, 298 may preferably form an angle Z with the substantially flat surfaces 196, 296 of between 30° and 90°, as illustrated in FIG. 4. The angle Z may also be formed with the longitudinal axis A of the spring seat assembly as the substantially flat surfaces 196, 296 are parallel to the longitudinal axis A of the spring seat assembly. The legs 188, 288 and 190, 290 may also include a chamfered outer surface 199, 299. The chamfered outer surface 199, 299 facilitates assembly of the spring seat assembly 158, 258 by easing insertion of the legs 188, 288, 190, 290 into the spring 176, 276.

Although the spring seat assemblies have been described herein with respect to rotary control valves, the disclosed spring seat assemblies may be used in valves that control other types of fluid flows.

Although certain spring seat assemblies have been described herein in accordance with the teachings of the present disclosure, the scope of coverage of this patent is not limited thereto. On the contrary, while the invention has been shown and described in connection with various preferred embodiments, it is apparent that certain changes and modifications, in addition to those mentioned above, may be made. This patent covers all embodiments of the teachings of the disclosure that fairly fall within the scope of permissible equivalents. Accordingly, it is the intention to protect all variations and modifications that may occur to one of ordinary skill in the art.

What is claimed is:

1. A spring seat assembly for a fluid valve, the spring seat assembly comprising:
a first spring seat having a first protruding member extending away from a first seating surface;
a second spring seat having a second protruding member extending away from a second seating surface;
a spring disposed between the first seating surface and the second seating surface; and
a locking element disposed on at least one of the first protruding member and the second protruding member,
wherein the first spring seat is slidable relative to the second spring seat.

2. The spring seat assembly of claim 1, wherein the first protruding member includes two legs.

3. The spring seat assembly of claim 2, wherein the second protruding member includes two legs.

4. The spring seat assembly of claim 1, wherein the locking element is a hook.

5. The spring seat assembly of claim 4, wherein the hook includes a shelf surface that is angled relative to a longitudinal axis of the spring seat assembly.

6. The spring seat assembly of claim 5, wherein the shelf surface forms an angle of between 30° and 90° relative to the longitudinal axis of the spring seat assembly.

7. The spring seat assembly of claim 6, wherein the shelf surface is substantially perpendicular to a longitudinal axis of the spring seat assembly.

8. The spring seat assembly of claim 1, wherein a distal end of one of the first protruding member and the second protruding member includes a chamfered surface.

9. The spring seat assembly of claim 1, wherein the locking element limits relative movement between the first spring seat and the second spring seat to less than an uncompressed length of the spring.

10. The spring seat assembly of claim 1, wherein one of the first protruding member and the second protruding member includes a curved outer surface.

11. A fluid valve comprising:
a valve body having a fluid inlet and a fluid outlet;
a closure member disposed within the valve body, the closure member being operatively coupled to a drive shaft and a follower shaft;
a valve seat disposed within the valve body, the valve seat cooperating with the closure member to control fluid flow through the valve body; and
a spring seat assembly operatively coupled to the follower shaft, the spring seat assembly including a first spring seat having a first protruding member extending away from a first seating surface, a second spring seat having a second protruding member extending away from a second seating surface, a spring disposed between the first seating surface and the second seating surface; and a locking element disposed on at least one of the first protruding member and the second protruding member.

12. The fluid valve of claim 11, wherein the fluid valve is mounted vertically with the drive shaft being located above the follower shaft.

13. The fluid valve of claim 12, wherein the spring seat assembly is located in a hollow bore in the follower shaft.

14. The fluid valve of claim 13, wherein the spring seat assembly is retained in the hollow bore by an end cap.

15. The fluid valve of claim 11, wherein the locking element is a hook.

16. The fluid valve of claim 15, wherein the hook includes a shelf surface that is angled relative to a longitudinal axis of the spring seat assembly.

17. The fluid valve of claim 16, wherein the shelf surface forms an angle of between 30° and 90° with the longitudinal axis of the spring seat assembly.

18. The fluid valve of claim 15, wherein the hook is located at a distal end of the at least one of the first protruding member and the second protruding member.

19. The fluid valve of claim 18, wherein the hook limits relative movement between the first spring seat and the second spring seat to less than an uncompressed length of the spring.

20. The fluid valve of claim 11, wherein the drive shaft and the follower shaft are integrally formed.
